(19) United States
(12) Patent Application Publication
(10) Pub. No.: US 2023/0089226 A1
(43) Pub. Date: Mar. 23, 2023

(54) SURFACE DEFECT INSPECTION DEVICE, VEHICLE BODY SURFACE DEFECT INSPECTION LINE AND SURFACE DEFECT INSPECTION PROCESS

(71) Applicant: CIN ADVANCED SYSTEMS GROUP S.L., Arrasate - Mondragon (ES)

(72) Inventors: Jorge MARINA JUAREZ, Arrasate-Mondragon (ES); Ignacio ALVAREZ GARCIA, Arrasate - Mondragon (ES); Daniel PEREZ GARCIA, Arrasate - Mondragon (ES)

(21) Appl. No.: 17/994,807

(22) Filed: Nov. 28, 2022

Related U.S. Application Data
(63) Continuation of application No. PCT/ES2020/070345, filed on May 26, 2020.

(51) Int. Cl. G01N 21/95; G01N 21/956; G01N 21/88

(52) U.S. Cl. CPC G01N 21/9515; G01N 21/956; G01N 21/8803; G01N 21/8806; G01N 2021/9518

(57) ABSTRACT

A surface defect inspection assembly that includes translation means configured to move a part in an advance direction in a first axis. The assembly also includes a structure that supports at least one mobile inspection head that is used for inspecting the surface of the part. The mobile inspection head including a light emitter configured to emit at least one light profile on the part and means for receiving the light reflected by the part. The assembly also includes a control unit that is configured to process the reflected light and to determine if a detect exists in the surface of the part. The control unit is additionally configured to activate one or more motors to move the mobile inspection head in response to the light reflected by the part while the translation means is moved in the advance direction, orienting the light profile towards the part.

### CROSS REFERENCE TO RELATED APPLICATIONS

This application relates to and claims the benefit and priority to International Application No. PCT/ES2020/070345, filed May 26, 2020, which is incorporated herein by reference in its entirety.

### FIELD

The present invention relates to the inspection of surface defects.

### BACKGROUND

Inspecting the surface of parts for detecting surface defects is known in the industry. For example, in the automotive industry, inspecting the component parts of vehicles, or the whole body of vehicles, to detect defects on the surface, before or after carrying out the painting operations, is known.

EP995108A1 discloses a surface defect inspection device comprising translation means movable according to an advance direction in a first axis, a supporting structure with inspection means for inspecting the surface of a part, the inspection means includes a light emitter that directs at least one light profile on the part and means for receiving light reflected by the part, and a control unit which is configured to process the reflected light and detect surface defects in the part.

### SUMMARY

Disclosed is a surface defect inspection device, a vehicle body surface defect inspection line and a surface defect inspection process.

One aspect of the invention relates to a surface defect inspection device comprising translation means movable according to an advance direction in a first axis, a supporting structure with inspection means for inspecting the surface of a part, the inspection means includes a light emitter that directs at least one light profile on the part and means for receiving the light reflected by the part, and a control unit which is configured to process the reflected light and detect surface defects in the part.

The inspection means comprise at least one mobile inspection head, and the control unit is additionally configured to move the inspection head in accordance with the light reflected by the light profile while the translation means are moved in the advance direction, orienting the light profile towards the part.

Another aspect of the invention relates to a vehicle body surface defect inspection line using the surface defect inspection device.

Another aspect of the invention relates to a surface defect inspection process by means of a surface defect inspection device comprising translation means movable according to an advance direction in a first axis, a supporting structure with inspection means for inspecting the surface of a part, the inspection means have means for emitting at least one light profile on the part and means for viewing the light reflected by the light profile emitted on the part, and a control unit which is configured to process the reflected light and detect surface defects in the part.

The process comprises:
moving the translation means that carries the part in the advance direction,
emitting the light profile on the part,
receiving the light reflected by the part, the light reflected by the part being associated with the light profile emitted on the part, and
while the translation means is moved in the advance direction, orienting the light profile towards the part based on the received reflected light.

The mobility of the inspection head according to the reflected light allows orienting the light profile, adapting it to the surface of the part, and therefore achieving the better orientation of the head for inspecting the part. Thus, the surface of the part can be inspected in real time while the translation means is moved. The light reflected by the part is used to command the movement of the inspection head and also to detect surface defects in the part.

EP995108A1 discloses a surface defect inspection device having inspection means with illuminators and cameras which can pivot with respect to a supporting structure for arranging the illuminators and the cameras in a suitable position for carrying out the inspection. The data representative of the surface of the part to be inspected is stored in a memory of a control unit, therefore the arrangement of the illuminators and the cameras is carried out in accordance with the type of part which is memorized in the control unit. This forces having to know the topography of the surface of the part in order to inspect it. However, the inspection device of the invention disclosed herein does not require knowing the surface of the part to be inspected, since the inspection head moves and adapts to the surface of the part while the translation means is moved, and at the same time the inspection is carried out, the light reflected by the part being used in both cases. Thus, the device can be used to inspect parts of different geometries, without needing to know the topography of the part, or requiring manually programming the movements of the inspection head in order to orient it towards the part and maintain it within its measurement range while the inspection is carried out.

These and other advantages and features will become evident in view of the figures and of the detailed description.

### BRIEF DESCRIPTION OF THE DRAWINGS

FIG. 1 shows a perspective view of the surface defect inspection device.

FIG. 2 shows a perspective view of an inspection head of the device of FIG. 1.

FIG. 3 shows an exploded view of the inspection head of FIG. 2.

FIGS. 4 to 8 show different positions in which the light profile emitted by the sensor of the inspection head can be oriented.

FIG. 8 shows a perspective view of the surface defect inspection device applicable to a vehicle body surface defect inspection line.

### DETAILED DESCRIPTION

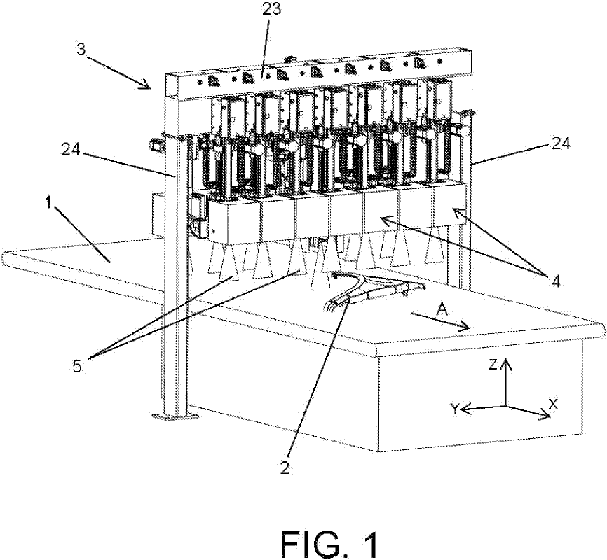

FIG. 1 shows a surface defect inspection device of the invention comprising translation means 1 movable in an advance direction A in a first axis X, and a supporting structure 3 with inspection means for inspecting the surface of a part 2.

The inspection means comprises at least one mobile inspection head 4 having means for emitting at least one light profile 5 on the part 2 and means for subsequently receiving the light reflected by the part 2.

The device includes a control unit (not depicted) which is configured to process data associated with the reflected light for the purpose of detecting surface defects in the part 2. The surface defects are determined by means of known techniques, such as, for example, three-dimensional laser triangulation.

The control unit is additionally configured to control motors that move the inspection head 4 in response to the light reflected by the part 2 while the translation means 1 is moved in the advance direction A, orienting the light profile 5 towards the part 2, such that the inspection head 4 adapts to the surface of the part 2 as the translation means 1 is moved in the advance direction A of the first axis X, to be arranged in the best possible orientation for carrying out the inspection of the surface of the part 2.

The processing of the reflected light for detecting surface defects in the part 2 and the processing of the light for moving the inspection head 4, can be carried out by one and the same control unit which is physically located in one and the same place, or can be carried out by two different control units physically located in different places. In any case, the light reflected by the light profile 5 is used to detect the surface defects and also to command the movements of the inspection head 4.

As shown in the figures, the translation means 1 is preferably configured to translate the part 2 according to the advance direction A in the first axis X, while the supporting structure 3 is static. Alternatively, the translation means 1 is configured to translate the supporting structure 3 with the inspection head 4 according to the advance direction A in the first axis X, while the part 2 is static.

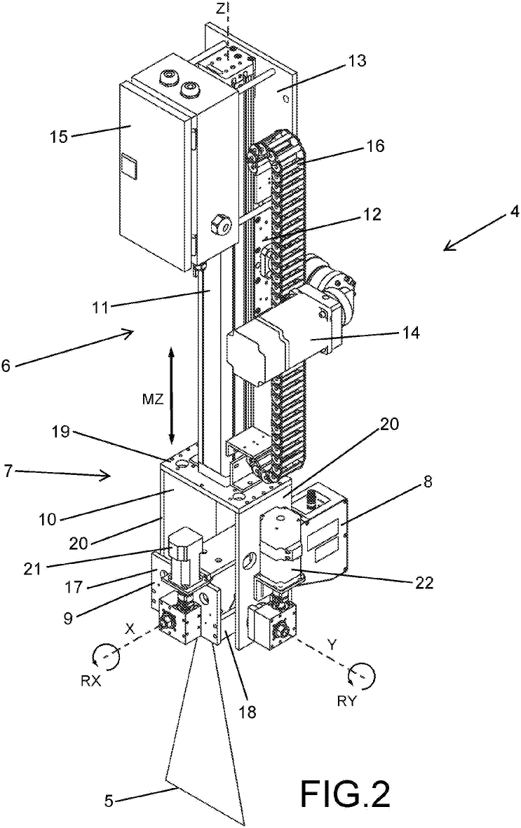

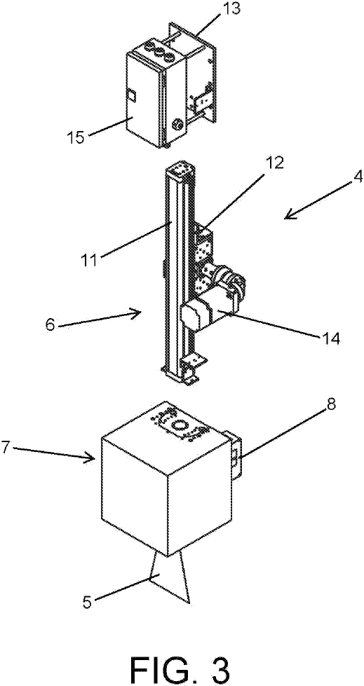

As observed in FIGS. 1 and 2, the inspection head 4 is mobile with respect to the supporting structure 3 according to a first rotational movement RX about the first axis X, a second rotational movement RY about a second axis Y, which is transverse to the first axis X, and a third translational movement MZ in a third axis Z, which is perpendicular to the plane formed by the first axis X and the second axis Y, the control unit being configured to control motors 14, 21, 22 to move the inspection head 4 according to the rotational movements RX, RY and translational movement MZ in accordance with the light reflected by the part 2 while the translation means 1 is moved, orienting the light profile 5 towards the part 2.

The inspection head 4 comprises a linear unit 6 movable in the third axis Z which has at one of its ends a support 7 of a sensor 8 having the means for emitting the light profile 5 and the means for subsequently receiving the light reflected by the part 2.

The support 7 of the sensor 8 has a first frame 9 and a second frame 10, the first frame 9 is joined in rotation with the sensor 8 to rotate the sensor 8 in the first rotational movement RX about the first axis X, and the second frame 10 is joined in rotation with the first frame 9 to rotate the sensor 8 and the first frame 9 in the second rotational movement RY about the second axis Y.

The linear unit 6 has a mobile part 11 which is vertically movable in the third axis Z with respect to a fixed part 12. The mobile part 11 is joined by its lower end with the support 7 of the sensor 8, and the fixed part 12 is joined to a plate 13 which is joined with the supporting structure 3. In the fixed part 12 there is arranged a motor 14 for vertically driving the mobile part 11 of the linear unit 6 in the third axis Z.

The first frame 9 has a U shape with an upper part 17 and two side flanges 18 projecting from the upper part 17, while the second frame 10 also has a U shape with an upper part 19 and two side flanges 20 projecting from the upper part 19. The upper part 17 of the first frame 9 is joined in rotation with the sensor 8, and in this upper part 17 there is arranged a first motor 21 for driving in rotation the sensor 8 about the first axis X. In addition, one of the side flanges 18 of the first frame 9 is joined in rotation to one of the side flanges 20 of the second frame 10, and the other one of the side flanges 18 of the first frame 9 is joined in rotation to the other one of the side flanges 20 of the second frame 10. In one of the side flanges 20 of the second frame 10 there is arranged a second motor 22 for rotating the sensor 8 and the first frame 9 about the second axis Y.

Coupled to the plate 13, and connecting the linear unit 6 with the supporting structure 3, there is arranged an electronics box 15 of the inspection device. The linear unit 6 has a cable holder 16 carrying power and control signals from the electronics box 15 to the sensor 8 and to the motors 14, 21 and 22.

With this arrangement of the inspection head 4, the support 7 of the sensor 8 is vertically movable in axis Z, while the sensor 8, which is arranged at the lower end of the head 4, and therefore closest to the surface of the part 2 to be inspected, is the one which has the rotational movements RX and RY respectively about axes X and Y. The vertical translational movement MZ is used so that the sensor 8 can adapt to changes in height in the part 2, and the rotational movements RX and RY are used so that the sensor 8 can adapt to different angles that the surface of the part 2 has, keeping the sensor 8 in its working range while the translation means 1 is moved to advance the part 2.

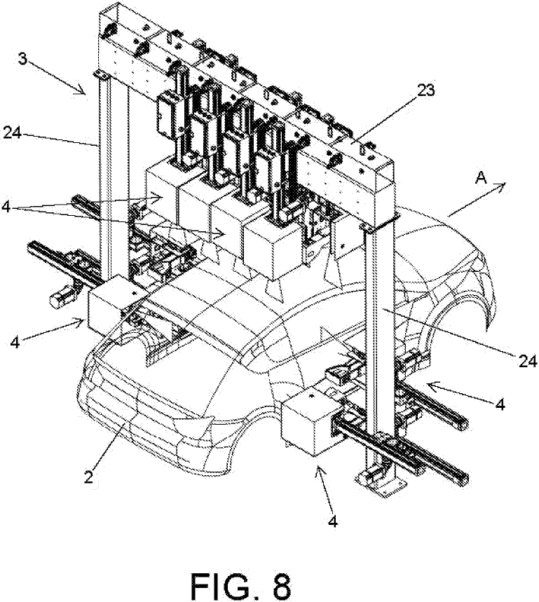

As shown in FIGS. 1 and 8, the supporting structure 3 is a gantry which is arranged in an upper position above the translation means 1, and the translation means 1 is configured to translate the part 2 in the advance direction A in the first axis X. Thus, the inspection head 4 is mobile with respect to the supporting structure 3, such that the vertical translational movement MZ allows moving the inspection head 4 closer to or away from the translation means 1, and the rotational movements RX and RY allow orienting the light profile 5 towards the part 2 which is translated on the translation means 1.

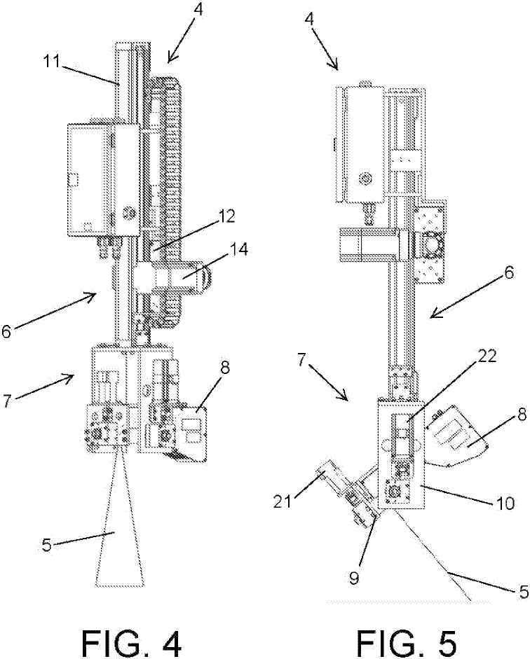

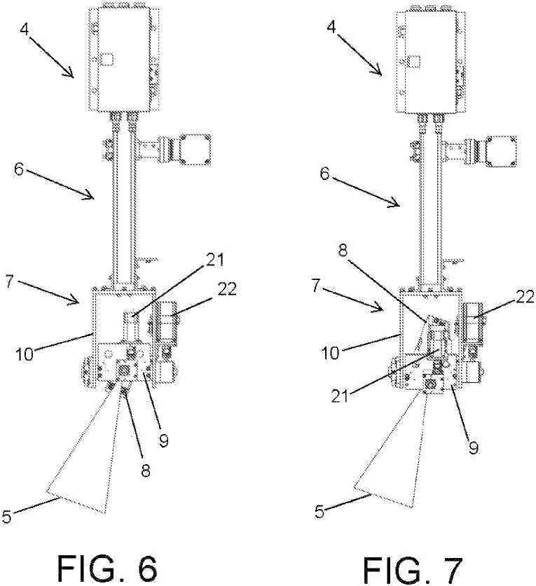

FIG. 4 shows the third translational movement MZ of the inspection head 4 in the third axis Z. FIG. 5 shows the second rotational movement RY of the inspection head 4 about the second axis Y. FIG. 6 shows the first rotational movement RX of the inspection head 4 about the first axis X. FIG. 7 shows a combination of the rotational movements RX and RY of the inspection head 4 respectively about axes X and Y.

The translation means 1 is a conveyor belt that supports and moves the part 2. Part 2 may be, for example, a component part of a vehicle as shown in FIG. 1. The translation means can also be a driving structure of the part 2, For example, part 2 can be the body of a vehicle as shown in FIG. 8 (For the sake of clarity, the translation means is not depicted in FIG. 8).

Alternatively, the translation means 1 can be guides moving the supporting structure 3 according to the advance direction A in the first axis X, the part 2 being static.

The translation means 1 can be part of a vehicle assembly line, such that the inspection device can be integrated in the line in a non-invasive manner, taking advantage of the translation means that the line has. Thus, the inspection device is especially suitable for being arranged in a vehicle body surface defect inspection line. The device can be arranged at the exit of a press line in which the component parts of the vehicles are manufactured, or at a point before or after the painting process of the body of the vehicle.

The translation means 1 is configured to translate the part 2, or the supporting structure 3, in the advance direction A in a continuous and stable manner. It being therefore a smooth movement, without the occurrence of abrupt changes which can hinder the processing of the reflected light.

The supporting structure 3 has a set of inspection heads 4 which are arranged in a first row upstream of the supporting structure 3 and a second row downstream of the supporting structure 3 according to the advance direction A of the translation means 1. The heads are arranged in an alternate manner, a head of the second row being arranged between two heads of the first row. Thus, the inspection heads 4 are arranged in a staggered manner, forming equilateral triangles between them. This arrangement is suitable for covering the width of the translation means 1 and so that there are no portions of the part 2 that escape inspection and so that the light profiles 5 do not overlap one another, and so that the reflected light associated with a particular light profile is received only in the sensor 8 that emitted the particular light profile.

Preferably, the light profile 5 impinges on the part 2 in a direction transverse to the advance direction A of the translation means 1, and even more preferably in a direction perpendicular to the advance direction A of the translation means 1, such that covering the width of the translation means 1 is aided, as shown in FIGS. 1 and 8.

As shown in FIG. 8, the gantry is formed by a crossbeam 23 supporting the inspection heads 4 and side columns 24 supporting other inspection heads 4 for laterally inspecting the part 2. This configuration is suitable for inspecting surface defects of vehicle bodies.

Each side column 24 has a first inspection head 4 arranged upstream of the column 24 and a second inspection head 4 arranged downstream of the column 24 according to the advance direction A of the translation means 1.

The inspection heads 4 of the side columns 24 can be fixed to the columns 24 with a predefined orientation towards the sides of the body 2, and therefore they do not require being mobile but rather they only need to have means for emitting a light profile 5 on a part 2 and thereafter receiving the light reflected by the part 2. In addition, it has been provided that all the inspection heads 4 arranged in the crossbeam 23 of the gantry are mobile in axes X, Y, and Z, nevertheless, in accordance with the part 2 to be inspected, some of the heads 4 could be fixed, or only mobile in axis Z. For example, the heads 4 of the crossbeam 23 closest to the side columns 24 could be fixed, or only mobile in axis Z, and be oriented towards the translation means 1.

Preferably, the sensor 8 of the inspection head 4 is a laser profilometer having an emitter for emitting a laser line 5 on the surface of the part 2 and a reflector having a lens for receiving the light reflected by the surface of the part 2 and sending it to an image sensor for its processing. The control unit processes the information of the distance between the profilometer 8 and the laser line 5, and obtains a three-dimensional reconstruction of the surface of the part 2 illuminated by the laser line 5.

The surface defect inspection process with the inspection device described above comprises:
moving the translation means 1 in the advance direction A,
emitting the light profile 5 on the part 2,
receiving the light reflected by the part 2, the light reflected by the part 2 being associated with the light profile 5 emitted on the part 2, and
while the translation means 1 is moved in the advance direction A, orienting the light profile 5 towards the part 2 based on the received reflected light.

The process allows calculating in real time the topography of the surface of the part 2, and foreseeing how the topography will evolve so that the sensor 8 of the inspection head 4 can adapt to it and always achieve that it is in the best possible orientation to search for surface defects. Thus, it is not necessary to program the movements of the sensor in advance, which can be quite a laborious process. Furthermore, it is not necessary for the part to always be located in one and the same area because, if the movements had to be programmed in advance, with a change of the position of the part, it would be necessary to recalculate the movements to achieve a better adjustment of the position of the sensors.

The light profile 5 emitted on the part 2, and therefore the light subsequently reflected by the part 2, varies as the translation means 1 advance, such that the inspection head 4 moves in axes X, Y, and Z to adapt the sensor 8 to these variations, orienting the light profile 5 towards the part 2.

The first rotational movement RX about the first axis X, and the second rotational movement RY about the second axis Y, are carried out according to the information provided by the light reflected by the part 2. The inspection head 4 moves in the first axis X, and in the second axis Y, to emit the light profile 5 substantially perpendicular to the surface of the part 2 while the translation means 1 is moved.

The rotational movements RX and RY attempt to search for the most favorable orientation of the light profile 5 on the surface of the part 2, and mainly that the light profile 5 is emitted substantially perpendicular to the surface of the part 2, so that the information obtained by the sensor 8 is of good quality, because, if the light profile 5 is emitted tangentially to the surface of the part 2, information with a lot of noise will be obtained because it will reflect little light.

To carry out the first rotational movement RX, the inclination of the light profile 5 emitted on the part 2 is determined. The projection of the light profile 5 emitted on the part 2 is a straight line, or a set of straight lines, such that by determining the gradient of said straight line it can be known if the surface is inclined, and therefore how much the sensor in the first axis X must be rotated in order to orient the light profile 5 towards the part 2.

To carry out the second rotational movement RY, a set of light profiles 5 emitted on the part 2 is determined while the translation means 1 advances during a determined time period. The height variation of some profiles with respect to others also allows knowing if the surface is inclined, and therefore how much the sensor in the second axis X must be rotated in order to orient the light profile 5 towards the part 2.

The third translational movement MZ in the third axis Z is also carried out in response to the light reflected by the part 2. The inspection head 4 is moved in the third axis Z to keep the distance between the inspection head 4 and the part 2 stable while the translation means 1 is moved.

To carry out the third translational movement MZ, the distance between the inspection head 4 and the part 2 is determined, and the head 4 is moved in axis Z to keep said distance stable while the translation means 1 is moved. Thus, the distance between the sensor 8 and the part 2 is kept within the working range of the sensor 8. Working range of the sensor 8 is understood as the range of distances within which the sensor works correctly.

All the features described in relation to the inspection device are considered to be also described for the inspection process insofar as it concerned therewith.

What is claimed is:

1. An assembly for inspecting defects in a surface of a part, the assembly comprising:
translation means configured to move the part in an advance direction in a first axis;
a first inspection head for inspecting the surface of the part, the first inspection head including a sensor having a light emitter that is configured to emit a light profile on the part, the sensor also including a lens that is configured to receive light reflected off the surface of the part and to direct the light reflected off the surface of the part towards an image sensor that generates surface data of the part, the light reflected by the part being associated with the light profile emitted on the part;
a support structure to which the first inspection head is coupled, the first inspection head being movable with respect to the supporting structure according to a first rotational movement on the first axis, a second rotational movement on a second axis which is transverse to the first axis, and a translational movement in a third axis which is perpendicular to first and second planes respectively formed by the first axis and the second axis, the inspection head including a linear unit movable in the third axis, a support of the sensor being attached to the linear unit;
a first motor coupled to the sensor support that drives the first rotational movement on the first axis;
a second motor coupled to the sensor support that drives the second rotational movement on the second axis;
a third motor coupled to the linear unit that drives the translational movement in the third axis;
wherein the support of the sensor has a first frame and a second frame, the first frame being joined in rotation with the sensor to rotate the first inspection head in the first rotational movement on the first axis, the second frame beings joined in rotation with the first frame to rotate the sensor and the first frame in the second rotational movement on the second axis.

2. The assembly according to claim 1, further comprising a control unit that is configured to control the first, second and third motors to respectively cause the first rotational movement, the second rotational movement and the translational movement in response to the generated surface data of the part.

3. The assembly according to claim 1, wherein the supporting structure is a gantry that is arranged in a position above the translation means.

4. The assembly according to claim 1, further comprising a second inspection head, the first inspection head being located upstream of the supporting structure according to the advance direction of the translation means, the second inspection head being located downstream the supporting structure according to the advance direction of the translation means.

5. The assembly according to claim 4, further comprising a third inspection head located upstream of the supporting structure according to the advance direction of the translation means, the first and third inspection heads being located in a row, the second inspection head being located between the first and third inspection heads.

6. The assembly according to claim 3, further comprising a second inspection head, the gantry being formed by a crossbeam and a side column, the crossbeam supports the first inspection head and the side column supports the second inspection head, the second inspection head being positioned on the side column for laterally inspecting the surface of the part.

7. The assembly according to claim 6, further comprising a third inspection device that is supported by the side column, the second inspection device being located upstream of the crossbeam according to the advance direction of the translation means, the third inspection head being located downstream of the crossbeam according to the advance direction of the translation means.

8. The assembly according to claim 1, wherein the light emitter is configured to direct the light profile on the surface of the part in a direction transverse to the advance direction of the translation means.

9. The assembly according to claim 1, wherein the sensor comprises a laser profilometer.

10. The assembly according to claim 1, wherein the translation means is a conveyor belt.

11. The assembly according to claim 1, wherein the part is a component fixed to a vehicle.

12. A method for inspecting defects in a surface of a part using the assembly according to claim 1, the method comprising:
transporting the part in the advance direction in the first axis;
emitting the light profile from the light emitter onto the surface of the part;
receiving the light reflected off the surface of the part in the image sensor and generating the surface data of the part based on the light reflected; and
moving the first inspection head to orient the light profile on the surface of the part based on the generated surface data while the translation means is moved in the advance direction, the first inspection head being moved with respect to the supporting structure according to one or more of the first rotational movement, the second rotational movement, and the translational movement by a respective activating of one or more of the first, second and third motors, the first frame of the support of the sensor being joined in rotation with the sensor to rotate the first inspection head in the first rotational movement on the first axis, the second frame of the support of the sensor being joined in rotation with the first frame to rotate the sensor and the first frame in the second rotational movement on the second axis.

13. The method according to claim 12, wherein the first inspection head moves in the first axis and in the second axis to cause the light profile to be substantially perpendicular to the surface of the part while the part moves with the translation means.

14. The method according to claim 12, wherein the first inspection head moves in the third axis to maintain a constant distance between the first inspection head and the surface of the part while the translation means moves.

15. The method according to claim 13, wherein the first inspection head moves in the third axis to maintain a constant distance between the first inspection head and the surface of the part while the translation means moves.

16. The method according to claim 12, wherein the translation means is a conveyor belt.

17. The method according to claim 12, wherein the part is a component fixed to a vehicle.

18. The method according to claim 12, wherein the sensor comprises a laser profilometer.
